(19) United States
(12) Patent Application Publication
(10) Pub. No.: US 2016/0349706 A1
(43) Pub. Date: Dec. 1, 2016

(54) SMART WATCH

(71) Applicant: JEN-TSORNG CHANG, Tu-Cheng (TW)

(72) Inventor: JEN-TSORNG CHANG, Tu-Cheng (TW)

(73) Assignee: HON HAI PRECISION INDUSTRY CO., LTD., New Taipei (TW)

(21) Appl. No.: 14/933,528

(22) Filed: Nov. 5, 2015

(30) Foreign Application Priority Data
May 28, 2015 (CN) 201510281119.5

(51) Int. Cl. G04B 37/12; G04B 37/14

(52) U.S. Cl. CPC G04B 37/12; G04B 37/1486

(57) ABSTRACT

A smart watch includes a first connecting structure, a second connecting structure and a main body. The main body is made of a flexible material, and physically and electrically connected between the first connecting structure and second connecting structure.

### CROSS-REFERENCE TO RELATED APPLICATIONS

This application claims priority to Chinese Patent Application No. 201510281119.5 filed on May 28, 2015, the contents of which are incorporated by reference herein.

### FIELD

The subject matter relates to a smart watch.

### BACKGROUND

Electronic devices can take many forms such as computers, smartphones, and smart watches. A smart watch can be configured to be coupled to another electronic device. Functionality of the smart watch can vary depending on components included therein.

### BRIEF DESCRIPTION OF THE DRAWINGS

Implementations of the present technology will now be described, by way of example only, with reference to the attached figures.

FIG. 1 is a top view of an expanded state of a smart watch in accordance with a first exemplary embodiment of the present disclosure.

FIG. 2 is a side view of the expanded state of the smart watch of FIG. 1.

FIG. 3 is a side view of an operating state of the smart watch of FIG. 1.

FIG. 4 is an elevational view of a first connecting portion and a second connecting portion of the smart watch of FIG. 1.

FIG. 5 is another elevational view of the first connecting portion and the second connecting portion of the smart watch of FIG. 1.

FIG. 6 is a top view of an expanded state of a smart watch in accordance with a second exemplary embodiment of the present disclosure.

FIG. 7 is a cross-sectional view of an expanded state of the smart watch of FIG. 6.

FIG. 8 is a cross-sectional view of an operating state of the smart watch of FIG. 6.

### DETAILED DESCRIPTION OF EMBODIMENTS

It will be appreciated that for simplicity and clarity of illustration, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure. The description is not to be considered as limiting the scope of the embodiments described herein.

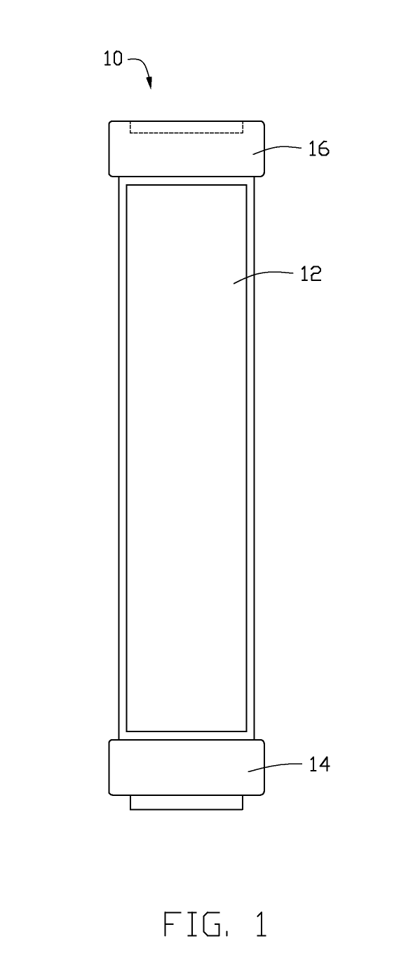

FIG. 1 provides an example smart watch 10 according to the present disclosure. The smart watch 10 includes a main body 12, a first connecting structure 14 and a second connecting structure 16. The main body 12 is physically and electrically connected between the first connecting structure 14 and second connecting structure 16.

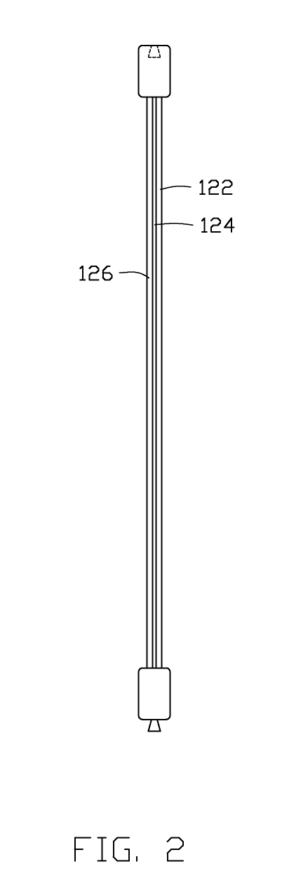

FIG. 2 illustrates an example of the main body 12 that is configured for displaying and attaching screens. The main body 12 includes a bottom layer 122, displaying layer 124 and a protecting layer 126. The displaying layer 124 is positioned between the bottom layer 122 and the protecting layer 126. The bottom layer 122, the displaying layer 124 and the protecting layer 126 has a same size.

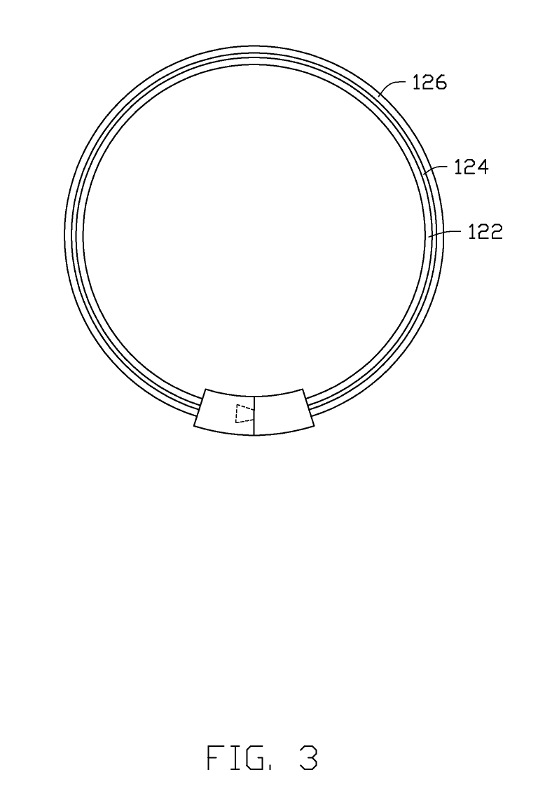

Referring to FIGS. 1 and 3, the smart watch 10 has two states, one state is an exploded state in which the smart watch 10 can be a flat ribbon, and another state is a operating state, in which the smart watch 10 can be a circle ribbon. When the smart watch 10 is placed on a wrist of a user (not shown), the first connecting structure 14 is coupled to the second connecting structure 16, the smart watch 10 can change from the flat ribbon to the circle ribbon, and the bottom layer 122 is adjacent to the arm. The main body 12 can be made of a flexible material. The bottom layer 122, the displaying layer 124 and the protecting layer 126 can be made of a flexible material. The bottom layer 122 can be made of a flexible stainless steel or a flexible memory alloy. The displaying layer 124 can be made of organic thin film transistors or active matrix organic light emitting diode. The protecting layer 126 can be made of a transparent material. The protecting layer 126 can be made of polyformaldehyde resins.

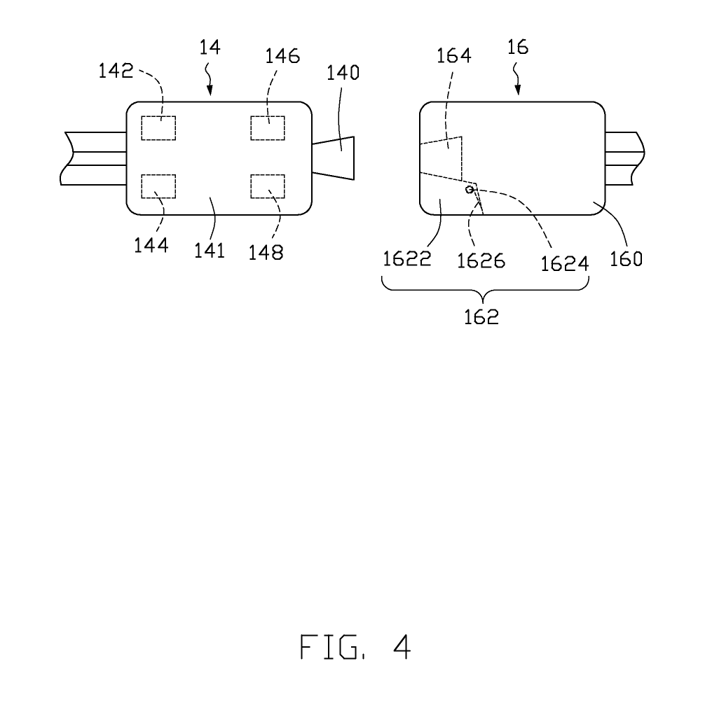

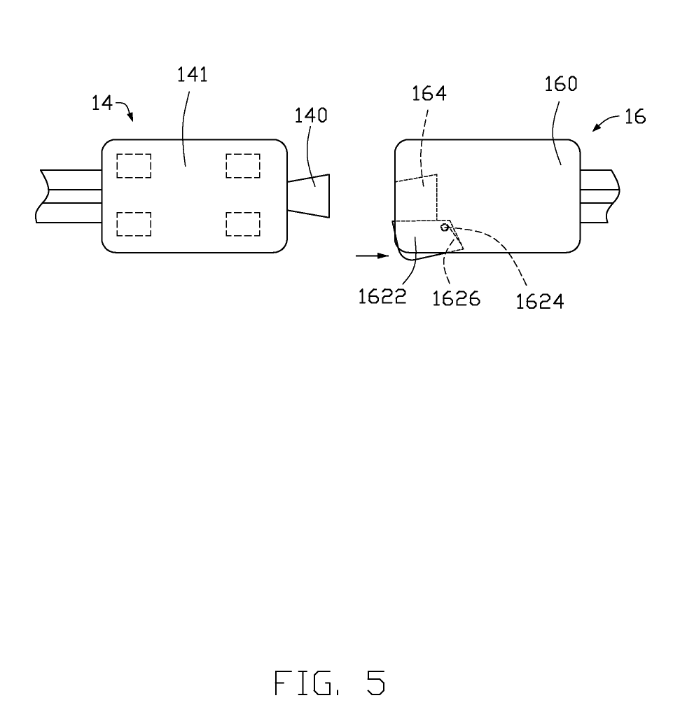

Referring to FIGS. 4 and 5, the first connecting structure 14 includes a first connecting portion 141 and a bumped structure 140. The bumped structure 140 can be a trapezoidal structure. The bumped structure 140 has a big end and a small end. The small end of the bumped structure 140 is connected to the first connecting portion 141.

The first connecting structure 14 further can include a camera module 142, a audio module 144, a controlling module 146 and a power supply 148. The camera module 142 can be configured for receiving pictures. The audio module 144 can be configured for receiving or making a sound. The controlling module 146 can be configured for controlling the camera module 142, the audio module 144 and the main body 12. The power supply 148 can provide a power for the main body 12, the camera module 142, the audio module 144 and the controlling module 146. The camera module 142, the audio module 144, the controlling module 146 and the power supply 148 can be positioned in the first connecting portion 141.

The second connecting structure 16 includes a second connecting portion 160 and a buckle device 162. A recess 164 is defined in the second connecting portion 160. The recess 164 can be a trapezoidal recess. The recess 164 has a small opening and a big bottom portion. The bumped structure 140 can be inserted into and maintained in the recess 164 for making the first connecting structure 14 and the second connecting structure 16 connected with each other.

The buckle device 162 includes a fastener 1622, a spindle 1624 and a torsional spring 1626. The spindle 1624 is fixed on the second connecting portion 160. The fastener 1622 is coupled with the spindle 1624 by the torsional spring 1626. The fastener 1622 rotates around the spindle 1624.

Referring to FIG. 5, the bumped structure 140 can be inserted into or pulled out from the recess 164 by rotating the fastener 1622 around the spindle 1624. When the bumped structure 140 is inserted into the recess 164, the torsional spring 1626 provide an initial elastic force for the bumped structure 140 maintains to in the recess 164. The fastener 1622 is an internal wall of the recess 164, and the fastener 1622 attaches to the bumped structure 140.

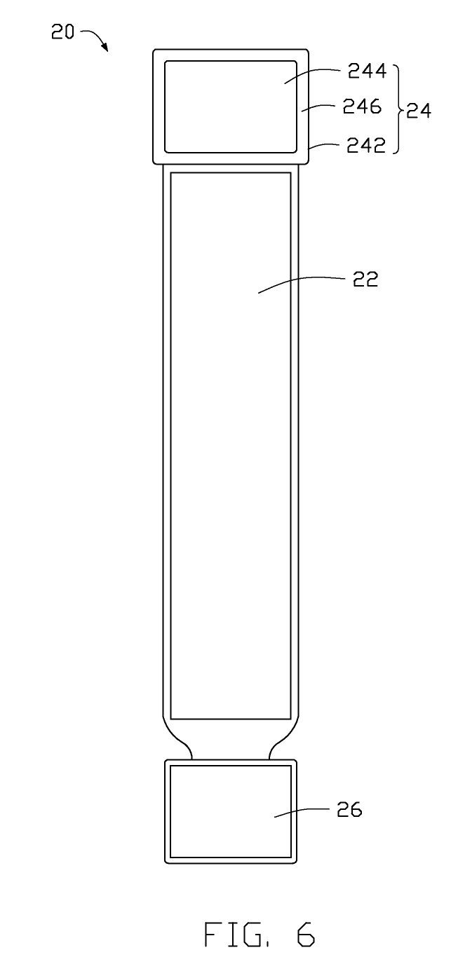

Referring to FIG. 6, a second exemplary embodiment of a smart watch 20 is provided. The smart watch 20 includes a main body 22, a first connecting structure 24 and a second connecting structure 26. The main body 22 is the same as the main body 12 of the smart watch 10. The main body 22 includes a bottom layer 222, a displaying layer 224 and a protecting layer 226.

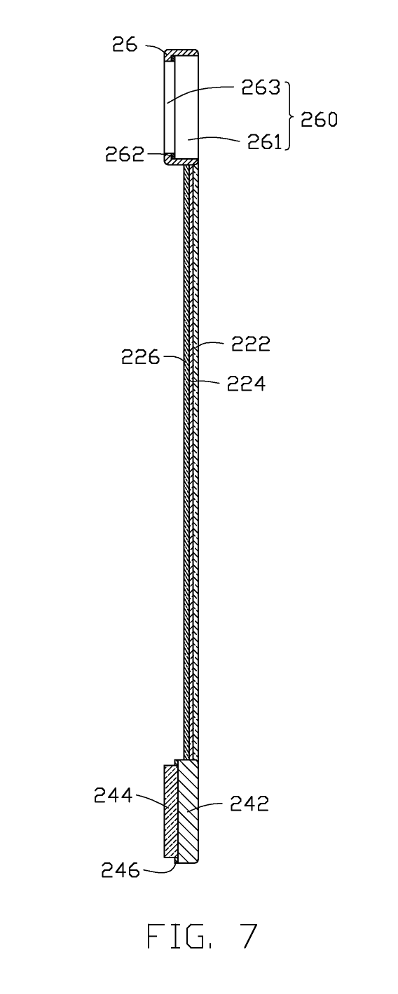

The first connecting structure 24 includes a circuit board 242, a displaying plate 244 and a sheet metal 246. The circuit board 242 and the displaying plate 244 are electrically connected with the main body 22. Referring to FIG. 7, the displaying plate 244 and the sheet metal 246 are formed on the circuit board 242. The sheet metal 246 is positioned around the displaying plate 244. A thickness of the sheet metal 246 is less than the thickness of the displaying plate 244. The displaying plate 244 and the main body 22 are configured for displaying and touching screens.

The second connecting structure 26 includes a chamber 260 and a magnetic structure 262. The chamber 260 includes a first portion 261 and a second portion 263 connected to the first portion 261.

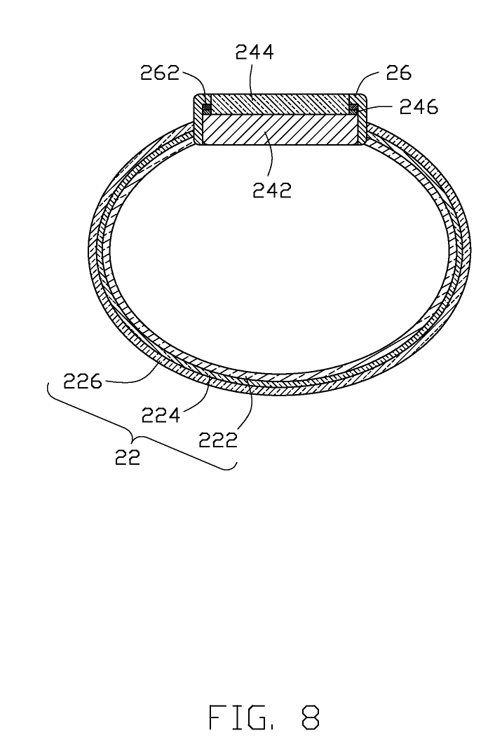

Referring to FIG. 8, when the smart watch 20 is placed on a wrist of a user, the circuit board 242 and the displaying plate 244 are received in the chamber 260. The circuit board 242, the sheet metal 246 and a part of the displaying plate 244 are received in the first portion 261. Another part of the displaying plate 244 is received in the second portion 263.

The magnetic structure 262 is position at a junction of the first portion 261 and the second portion 263. When the circuit board 242 and the displaying plate 244 are received in the chamber 260, the magnetic structure 262 is able to be attracted the sheet metal 246, and the circuit board 242 and the displaying plate 244 maintains in the chamber 260.

The embodiments shown and described above are only examples. Many details are often found in the art such as the other features of a smart watch. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A smart watch comprising:
a first connecting structure;
a second connecting structure; and
a main body configured for displaying and attaching screens, the main body made of a flexible material and being physically and electrically connected between the first connecting structure and second connecting structure.

2. The smart watch of claim 1, wherein the smart watch has two states, one state is an exploded state in which the smart watch is a flat ribbon, another state is an operating state in which the smart watch is a circle ribbon.

3. The smart watch of claim 2, wherein the first connecting structure is coupled to the second connecting structure, the smart watch changes from the flat ribbon to the circle ribbon.

4. The smart watch of claim 3, wherein the main body comprises a bottom layer, displaying layer and a protecting layer, the displaying layer is positioned between the bottom layer and the protecting layer.

5. The smart watch of claim 4, wherein the bottom layer, the displaying layer and the protecting layer has a same size.

6. The smart watch of claim 5, wherein the first connecting structure comprises a first connecting portion and a bumped structure.

7. The smart watch of claim 6, wherein the bumped structure is a trapezoidal structure, the bumped structure has a big end and a small end, the small end of the bumped structure is connected to the first connecting portion.

8. The smart watch of claim 6, wherein the first connecting structure further comprises a camera module, a audio module, a controlling module and a power supply positioned in the first connecting portion.

9. The smart watch of claim 6, wherein the second connecting structure 16 comprises a second connecting portion and a buckle device, and a recess is defined in the second connecting portion, the bumped structure is inserted into and maintained in the recess for making the first connecting structure and the second connecting structure connected with each other.

10. The smart watch of claim 9, the recess is a trapezoidal recess, and the recess has a small opening and a big bottom portion.

11. The smart watch of claim 9, wherein the buckle device comprises a fastener, a spindle and a torsional spring, the spindle is fixed on the second connecting portion, the fastener is coupled with the spindle by the torsional spring, and the fastener rotates around the spindle.

12. The smart watch of claim 9, wherein the bumped structure is inserted into or pulled out from the recess by rotating the fastener around the spindle.

13. The smart watch of claim 5, wherein the first connecting structure comprises a circuit board, a displaying plate and a sheet metal.

14. The smart watch of claim 13, wherein the displaying plate and the sheet metal are formed on the circuit board, the sheet metal is positioned around the displaying plate.

15. The smart watch of claim 14, wherein the second connecting structure comprises a chamber, the circuit board and the displaying plate are received in the chamber.

16. The smart watch of claim 15, wherein the chamber comprises a first portion and a second portion connected to the first portion, the circuit board, the sheet metal and a part of the displaying plate are received in the first portion, another part of the displaying plate is received in the second portion.

17. The smart watch of claim 16, wherein the second connecting structure further comprises a magnetic structure, when the circuit board and the displaying plate are received in the chamber, the magnetic structure is able to be attracted the sheet metal, and the circuit board and the displaying plate maintains in the chamber.

18. The smart watch of claim 17, wherein the magnetic structure is position at a junction of the first portion and the second portion.
